(19) United States
(12) Patent Application Publication
(10) Pub. No.: US 2019/0182830 A1
(43) Pub. Date: Jun. 13, 2019

(54) BASE STATION APPARATUS, TERMINAL APPARATUS, RADIO COMMUNICATION SYSTEM, AND TRANSMISSION TIMING SETTING METHOD

(71) Applicant: FUJITSU LIMITED, Kawasaki-shi (JP)

(72) Inventors: Hongyang CHEN, Kawasaki (JP); Jianming Wu, Kawasaki (JP); Tsuyoshi Shimomura, Yokohama (JP)

(73) Assignee: FUJITSU LIMITED, Kawasaki-shi (JP)

(21) Appl. No.: 16/275,062

(22) Filed: Feb. 13, 2019

Related U.S. Application Data
(63) Continuation of application No. PCT/JP2017/035275, filed on Sep. 28, 2017.

(51) Int. Cl. H04W 72/04

(52) U.S. Cl. CPC H04W 72/0446; H04W 72/0406

(57) ABSTRACT

A base station apparatus includes: first processor circuitry that generates a first signal indicating first candidates for a transmission timing, wherein the first candidates are selected from a second candidates; second processor circuitry that generates a second signal specifying one transmission timing from the first candidates for the transmission timing indicated by the first signal; and a transmitter that transmits the first signal and the second signal.

### CROSS-REFERENCE TO RELATED APPLICATION

This application is a continuation of International Application No. PCT/JP2017/035275, filed on Sep. 28, 2017, the entire contents of which are incorporated herein by reference.

### FIELD

The embodiments discussed herein are related to a base station apparatus, a terminal apparatus, a radio communication system, and a transmission timing setting method.

### BACKGROUND

In a current network, traffic of mobile terminals (smart phones or feature phones) occupies most of the resources of the network. In addition, the traffic used by the mobile terminals will be increased in the future.

Meanwhile, in accordance with the development of Internet of things (IoT) services (for example, traffic systems, smart meters, monitoring systems for apparatuses, and the like), it has been demanded to cope with services having various requirements. For this reason, in a communication standard of the next generation (for example, fifth generation mobile communication (5G)), a technique that realizes a high data rate, a large capacity, and a low latency has been demanded in addition to standard technology (for example, 3GPP TS 36.211 V14.2.0 (2017-03), 3GPP TS 36.212 V14.2.0 (2017-03), 3GPP TS 36.213 V14.2.0 (2017-03), 3GPP TS 36.300 V14.2.0 (2017-03), 3GPP TS 36.321 V14.2.0 (2017-03), 3GPP TS 36.322 V14.0.0 (2017-03), 3GPP TS 36.323 V14.2.0 (2017-03), 3GPP TS 36.331 V14.2.0 (2017-03), 3GPP TS 36.413 V14.2.0 (2017-03), 3GPP TS 36.423 V14.2.0 (2017-03), 3GPP TS 36.425 V14.0.0 (2017-03)) of fourth generation mobile communication (4G). For the next generation communication standards, technical studies have been conducted by working groups (for example, TSG-RAN WG1, TSG-RAN WG2, and the like) of third generation partnership project (3GPP) (3GPP TR 38.801 V14.0.0 (2017-03), 3GPP TR 38.802 V14.0.0 (2017-03), 3GPP TR 38.803 V14.0.0 (2017-03), 3GPP TR 38.804 V14.0.0 (2017-03), 3GPP TR 38.900 V14.2.0 (2016-12), 3GPP TR 38.912 V14.0.0 (2017-03), 3GPP TR 38.913 V14.2.0 (2017-03), “New SID Proposal: Study on New Radio Access Technology”, NTT docomo, RP-160671, 3GPP TSG RAN Meeting #71, Goteborg, Sweden, 7.-10. March, 2016).

As described above, in order to cope with the various services, in 5G, it is assumed to support many use cases classified into enhanced mobile broadband (eMBB), massive machine type communications (MTC), and ultra-reliable and low latency communication (URLLC).

Among them, the URLLC is the most difficult use case to be realized. First, there is a demand for ultra-high reliability such as setting an error rate in a radio section to an order of 10⁻⁵. As one method of realizing the ultra-high reliability, there is a method of causing data to have redundancy by increasing an amount of use resources. However, since there is a limitation in radio resources, it is not possible to unlimitedly increase the use resources.

By the way, in 4G long term evolution (LTE), and the like, a hybrid automatic repeat request (HARQ) technique has been used in order to realize efficient data transmission. In the HARQ, a receiving apparatus requests a transmitting apparatus to retransmit data that is not correctly decoded in processing of a layer-1 protocol layer such as LTE. When the retransmission of the data is requested, the transmitting apparatus transmits retransmission data corresponding to the data that is not correctly decoded by the receiving apparatus. The receiving apparatus combines the data that is not correctly decoded and the retransmission data with each other to decode the data. Therefore, a highly efficient and highly accurate retransmission control is realized.

In the HARQ in such 4G LTE, a timing at which the receiving apparatus requests the retransmission is fixed. That is, the receiving apparatus is defined so as to transmit a feedback such as ACK/NACK a predetermined time after receiving the data. On the other hand, currently, at the 3GPP meeting, techniques related to an HARQ feedback method corresponding to the next generation communication manner have been discussed, and for example, it has been studied to enable the feedback at a plurality of timings with respect to an HARQ feedback timing (“Downlink HARQ-ACK feedback timing”, CMCC, R1-1705106, 3GPP TSG RAN WG1 Meeting #88bis Meeting, Spokane, USA, 3-7 Apr. 2017).

However, a method of setting a timing of the feedback such as ACK/NACK has not been studied in detail yet. For this reason, it is difficult for the receiving apparatus to determine at which timing of the plurality of timings to perform feedback to the transmitting apparatus when the data is received.

In addition, as an example of a terminal apparatus that becomes the receiving apparatus in downlink communication, there are terminal apparatuses having various processing capabilities. For this reason, times to decode the data by the terminal apparatuses are different from each other, such that times at which the feedback of ACK/NACK becomes possible are also different from each other. Therefore, it is preferable to make timings of the feedback individually settable depending on the processing capabilities, or the like, of the terminal apparatuses.

Such a problem does not exist only with respect to the feedback of ACK/NACK. For example, it is preferable to make a timing flexibly settable also when a terminal apparatus allowed to perform uplink communication from a base station apparatus determines a timing at which the terminal apparatus actually performs uplink transmission.

### SUMMARY

According to an aspect of an embodiment, a base station apparatus includes: first processor circuitry that generates a first signal indicating first candidates for a transmission timing, wherein the first candidates are selected from a second candidates; second processor circuitry that generates a second signal specifying one transmission timing from the first candidates for the transmission timing indicated by the first signal; and a transmitter that transmits the first signal and the second signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a configuration of a radio communication system according to an embodiment;

FIG. 2 is a block diagram illustrating a configuration of a base station apparatus according to the embodiment;

FIG. 3 is a flowchart illustrating operations of the base station apparatus according to the embodiment;

FIG. 4 is a view illustrating a specific example of candidates for a transmission timing;

FIG. 5 is a view illustrating a specific example of narrowing a transmission timing;

FIG. 6 is a block diagram illustrating a configuration of a terminal apparatus according to the embodiment;

FIG. 7 is a flowchart illustrating operations of the terminal apparatus according to the embodiment;

FIG. 8 is a view illustrating another specific example of candidates for a transmission timing;

FIG. 9 is a view illustrating another specific example of narrowing a transmission timing;

FIG. 10 is a view illustrating still another specific example of candidates for a transmission timing;

FIG. 11 is a view illustrating still another specific example of narrowing a transmission timing; and

FIG. 12 is a view illustrating a specific example of a slot configuration according to another embodiment.

### DESCRIPTION OF EMBODIMENTS

Preferred embodiments of the present invention will be explained with reference to accompanying drawings. The present invention is not limited by this embodiment.

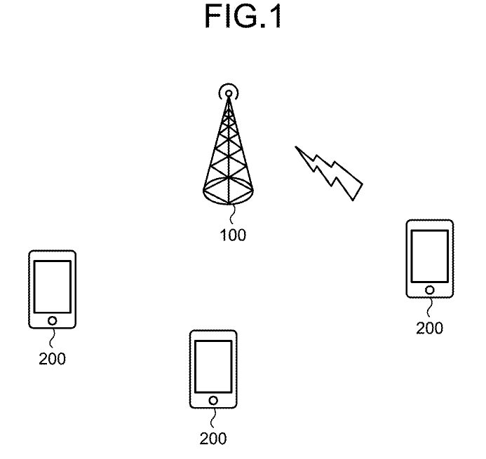

FIG. 1 is a view illustrating a configuration of a radio communication system according to an embodiment. The radio communication system illustrated in FIG. 1 includes a base station apparatus 100 and a plurality of terminal apparatuses 200.

The base station apparatus 100 transmits and receives data such as eMBB data and URLLC data to and from the terminal apparatus 200. In addition, the base station apparatus 100 sets a transmission timing for the terminal apparatus 200 to transmit a feedback for the data. That is, the base station apparatus 100 transmits a candidate notifying signal that notifies candidates for the transmission timing of the terminal apparatus 200, and further transmits a narrowing signal that narrows the transmission timing of the terminal apparatus 200 from the candidate timing. That is, the base station apparatus 100 sets the transmission timing of the terminal apparatus 200 by transmitting the signals in two steps.

The terminal apparatus 200 transmits and receives data such as eMBB data and URLLC data to and from the base station apparatus 100. The terminal apparatus 200 transmits an uplink signal at the transmission timing set by the base station apparatus 100. That is, the terminal apparatus 200 controls a transmission timing of, for example, ACK/NACK for received data depending on the setting by the base station apparatus 100.

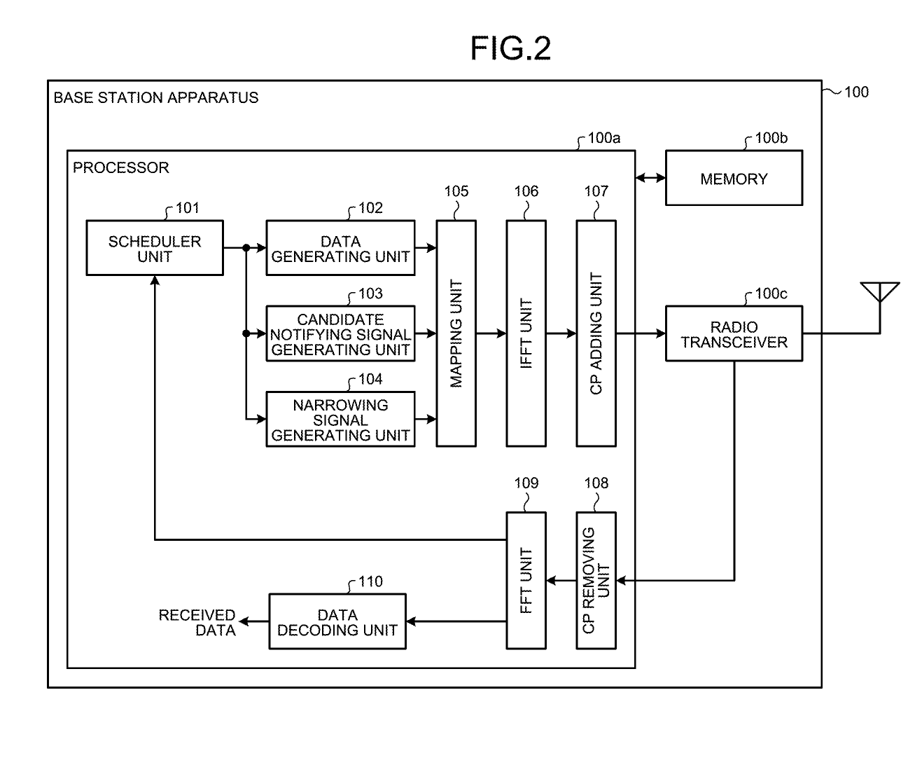

FIG. 2 is a block diagram illustrating a configuration of the base station apparatus 100 according to the embodiment. The base station apparatus 100 illustrated in FIG. 2 includes a processor 100a, a memory 100b, and a radio transceiver 100c.

The processor 100a includes, for example, a central processing unit (CPU), a field programmable gate array (FPGA), a digital signal processor (DSP), or the like, and generally controls the entire base station apparatus 100. Specifically, the processor 100a includes a scheduler unit 101, a data generating unit 102, a candidate notifying signal generating unit 103, a narrowing signal generating unit 104, a mapping unit 105, an inverse fast Fourier transform (IFFT) unit 106, a cyclic prefix (CP) adding unit 107, a CP removing unit 108, a fast Fourier transform (FFT) unit 109, and a data decoding unit 110.

The scheduler unit 101 executes scheduling for allocating radio resources to data transmitted to and received from the plurality of terminal apparatuses 200. Specifically, the scheduler unit 101 dynamically determines whether to set each slot to a downlink slot or an uplink slot, with respect to a frame having a plurality of slots. In this case, the scheduler unit 101 determines a frame configuration for each frequency interval (hereinafter, referred to as a “subcarrier interval”) of a plurality of subcarriers used to transmit and receive the data. That is, for example, the scheduler unit 101 determines a frame configuration in a subband with a subcarrier interval of 15 kHz and a frame configuration in a subband with a subcarrier interval of 60 kHz. Generally, the subcarrier interval and a symbol length indicating a time length of one symbol are inversely proportional to each other, such that the symbol length becomes shorter as the subcarrier interval becomes larger and the symbol length becomes longer as the subcarrier interval becomes smaller. Therefore, a time length of the slot is also changed depending on the subcarrier interval.

When the scheduler unit 101 determines the frame configuration including the downlink and uplink slots, the scheduler unit 101 determines data destined to a terminal apparatus to which each of the downlink slots is allocated, and notifies an allocation result to the data generating unit 102. In addition, the scheduler unit 101 may determine to allocate the uplink slot to the terminal apparatus 200 depending on a request from the terminal apparatus 200, and may execute uplink scheduling for notifying an allocation result to the terminal apparatus 200.

The data generating unit 102 generates data to be transmitted to the terminal apparatus 200 depending on downlink scheduling by the scheduler unit 101. That is, the data generating unit 102 encodes and modulates data destined to each terminal apparatus 200 to which the downlink slots are allocated.

The candidate notifying signal generating unit 103 generates a candidate notifying signal that indicates candidates for a transmission timing of an uplink signal in the frame configuration of each subcarrier interval, when the frame configuration for each subcarrier interval is determined by the scheduler unit 101. That is, the candidate notifying signal generating unit 103 generates a candidate notifying signal that indicates slots likely to become uplink slots on the basis of downlink slots. For example, the candidate notifying signal generating unit 103 generates a candidate notifying signal that indicates slots after two, three, six, and eight slots from the downlink slot as candidates for an uplink transmission timing in the subband with the subcarrier interval of 15 kHz and indicates slots after one, four, five, and seven slots from the downlink slot as candidates for an uplink transmission timing in the subband with the subcarrier interval of 60 kHz.

The narrowing signal generating unit 104 generates a narrowing signal that narrows a transmission timing of the corresponding uplink signal for each downlink slots. That is, the narrowing signal generating unit 104 generates a narrowing signal that specifies a transmission timing at which the uplink signal is actually transmitted, among a plurality of candidates for the transmission timing notified by the candidate notifying signal. For example, the narrowing signal generating unit 104 generates a narrowing signal that specifies an uplink slot after three slots from the downlink slot as the transmission timing in the subband with the subcarrier interval of 15 kHz and specifies an uplink slot after five slots from the downlink slot as the transmission timing in the subband with the subcarrier interval of 60 kHz.

The mapping unit 105 maps the data, the candidate notifying signal, and the narrowing signal to the radio resources to generate a transmission signal. That is, the mapping unit 105 arranges the data, the candidate notifying signal, and the narrowing signal in the subcarrier and the slot depending on the scheduling. In this case, the mapping unit 105 may map the candidate notifying signal as a higher layer signal such as radio resource control (RRC) signaling. Further, the mapping unit 105 may arrange the data in a data channel region of the downlink slot and arrange the narrowing signal in a control channel region of the downlink slot. The narrowing signal of the same slot as that of the data specifies an uplink transmission timing corresponding to this data. Therefore, for example, a transmission timing of ACK/NACK for the data is specified by the narrowing signal within the same slot.

The IFFT unit 106 performs inverse fast Fourier transform on the transmission signal generated by the mapping unit 105 to generate a transmission signal in a time domain. The IFFT unit 106 outputs the transmission signal to the CP adding unit 107.

The CP adding unit 107 adds a CP to the transmission signal output from the IFFT unit 106. The CP adding unit 107 outputs the transmission signal to which the CP is added to the radio transceiver 100c.

The CP removing unit 108 removes a CP added to a received signal. The CP removing unit 108 outputs the received signal after the removal of the CP to the FFT unit 109.

The FFT unit 109 performs fast Fourier transform on the received signal output from the CP removing unit 108 to convert the received signal into a received signal in a frequency domain. The received signal includes data transmitted by the terminal apparatus 200 in the uplink slot or feedback data such as ACK/NACK.

The data decoding unit 110 demodulates and decodes the received signal, and outputs received data. When the feedback data such as ACK/NACK is included in the received signal, the scheduler unit 101 may control retransmission of the data depending on the received data.

The memory 100b includes, for example, a random access memory (RAM), a read only memory (ROM), or the like, and stores various pieces of information when processing is executed by the processor 100a.

The radio transceiver 100c performs radio transmission processing such as digital/analog (D/A) conversion and up-conversion on the transmission signal output from the CP adding unit 107. The radio transceiver 100c transmits the transmission signal through an antenna. In addition, the radio transceiver 100c receives a signal through the antenna, and performs radio reception processing such as down-conversion and analog/digital (A/D) conversion on the received signal. The radio transceiver 100c outputs the received signal to the CP removing unit 108.

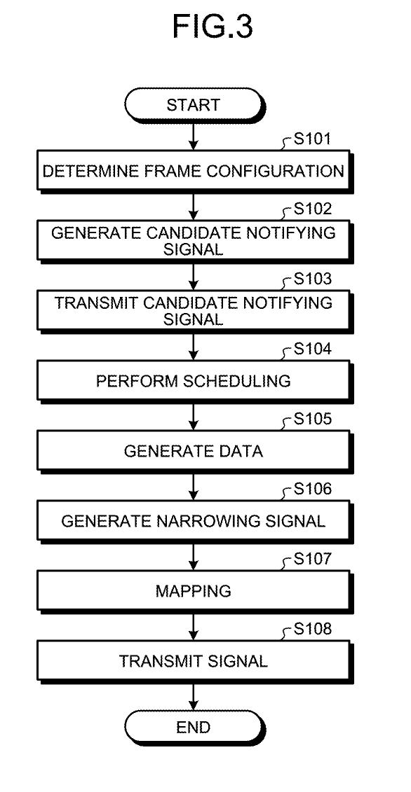

Next, operations of the base station apparatus 100 configured as described above will be described with reference to a flowchart illustrated in FIG. 3 together with a specific example.

First, the frame configuration is determined by the scheduler unit 101 (Step S101). Specifically, it is determined whether to set each of the plurality of slots constituting the frame to the downlink slot or the uplink slot. The frame configurations may be different from each other depending on the subcarrier intervals, and the downlink and uplink slots are arranged independently for each of the subbands with different subcarrier intervals.

When the frame configuration is determined, the candidate notifying signal is generated by the candidate notifying signal generating unit 103 (Step S102). The candidate notifying signal is a signal indicating candidates for an uplink transmission timing for each subcarrier interval. Therefore, the candidate notifying signal designates slots that follow the downlink slot on the basis of the downlink slot and can become the uplink slots.

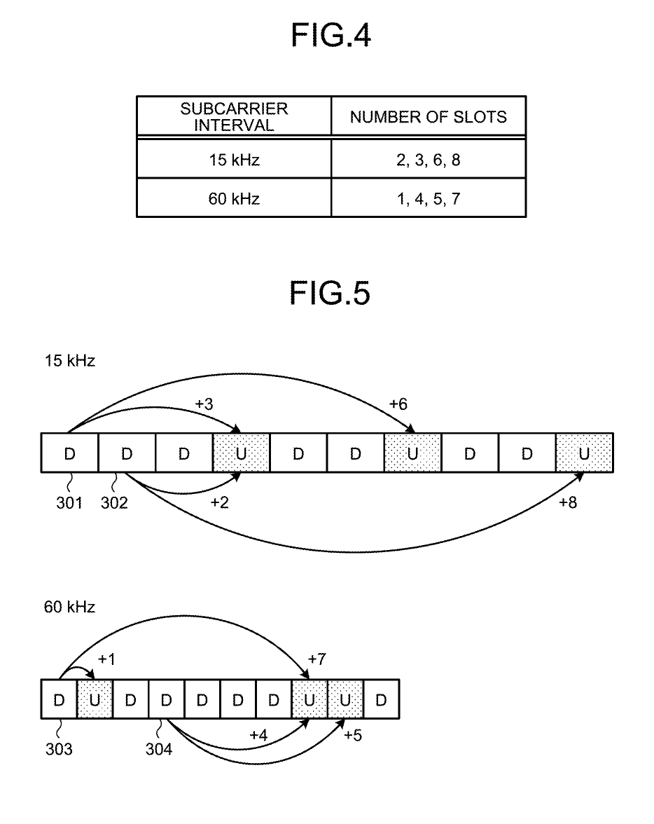

Specifically, for example, as illustrated in FIG. 4, the candidate notifying signal indicates the numbers of slots from the downlink slot to the slots that can become the uplink slots for each of the different subcarrier intervals. In the example illustrated in FIG. 4, the candidate notifying signal indicates that slots after two, three, six, and eight slots from the downlink slot can become uplink slots in the subband with the subcarrier interval of 15 kHz, and indicates that slots after one, four, five, and seven slots from the downlink slot can become uplink slots in the subband with the subcarrier interval of 60 kHz. As described above, the candidate notifying signal may designate different candidates for the transmission timing depending on the subcarrier intervals. Since the subcarrier interval and the symbol length are inversely proportional to each other, the candidate notifying signal also indicates candidates for the uplink transmission timing for each symbol length.

Returning to FIG. 3, when the candidate notifying signal is generated, the candidate notifying signal passes through the mapping unit 105, the IFFT unit 106, and the CP adding unit 107, and is then transmitted from the radio transceiver 100c through the antenna (Step S103). The candidate notifying signal may be transmitted at the time of starting communication with the terminal apparatus 200 or changing the frame configuration. In addition, the candidate notifying signal may be transmitted as a higher layer signal such as RRC signaling. Further, the candidate notifying signal may be transmitted using a physical downlink control channel (PDCCH) common to a group including the plurality of terminal apparatuses 200.

During communication between the base station apparatus 100 and the terminal apparatus 200, the scheduling for allocating the radio resources to the data destined to the terminal apparatus 200 is executed by the scheduler unit 101 (Step S104). In the downlink scheduling, for example, a report of radio quality is received from the terminal apparatus 200, and a subcarrier and a downlink slot in which the data destined to the terminal apparatus 200 is transmitted are determined depending on the radio quality. Like the downlink scheduling, uplink scheduling that determines a subcarrier and an uplink slot in which the terminal apparatus 200 transmits the data may be executed.

When the downlink scheduling is executed, the data destined to the terminal apparatus 200 depending on the scheduling is generated by the data generating unit 102 (Step S105). That is, the data destined to the terminal apparatus 200 is encoded and modulated. In addition, the narrowing signal that narrows the uplink transmission timing corresponding to the data generated by the data generating unit 102 is generated by the narrowing signal generating unit 104 (Step S106). That is, since the candidates of the transmission timing for each subcarrier interval have been notified to the terminal apparatus 200 by the candidate notifying signal, the narrowing signal that specifies the transmission timing at which the terminal apparatus 200 actually transmits the uplink signal among these candidates is generated.

Specifically, for example, as illustrated in FIG. 5, for each of the downlink slots (denoted by “D” in FIG. 5), slots that become actually uplink slots (denoted by “U” in FIG. 5) among the slots that become candidates for the transmission timing are specified as the transmission timings. For example, as illustrated in FIG. 5, in the case of a slot 301 of the subband with the subcarrier interval of 15 kHz, since slots after three slots and six slots from the slot 301 are uplink slots, the narrowing signal specifies the number of slots of three or six among candidates of the numbers of slots of two, three, six, and eight notified by the candidate notifying signal. In addition, in the case of a slot 302, since slots after two slots and eight slots from the slot 302 are uplink slots, the narrowing signal specifies the number of slots of two or eight among candidates of the numbers of slots of two, three, six, and eight notified by the candidate notifying signal.

Likewise, in the case of a slot 303 of the subband with the subcarrier interval of 60 kHz, since slots after one slot and seven slots from the slot 303 are uplink slots, the narrowing signal specifies the number of slots of one or seven among candidates of the numbers of slots of one, four, five, and seven notified by the candidate notifying signal. In addition, in the case of a slot 304, since slots after four slots and five slots from the slot 304 are uplink slots, the narrowing signal specifies the number of slots of four or five among candidates of the numbers of slots of one, four, five, and seven notified by the candidate notifying signal.

The transmission timing specified by the narrowing signal may be determined depending on, for example, a processing capability of the terminal apparatus 200, which is a destination of the data. That is, when the processing capability of the terminal apparatus 200 is high and the decoding of the data is relatively fast, an early timing among the candidates for the transmission timing may be specified as an actual transmission timing, and when the processing capability of the terminal apparatus 200 is low and the decoding of the data is relatively slow, a late timing among the candidates for the transmission timing may be specified as an actual transmission timing. In the present embodiment, since the candidates for the transmission timing are designated in advance by the candidate notifying signal, it is sufficient for the narrowing signal to designate the actual transmission timing among the candidates. For this reason, a bit size of the narrowing signal can be relatively small, such that an increase in control information can be suppressed.

Returning to FIG. 3, when the data and the narrowing signal are generated, the data and the narrowing signal are mapped to the radio resources by the mapping unit 105 (Step S107). That is, the data and the narrowing signal are arranged in the subcarrier and the downlink slot depending on the downlink scheduling by the scheduler unit 101. In this case, the data is arranged in the data channel region of the slot, and the narrowing signal corresponding to the data is arranged in the control channel region of the same slot. That is, the transmission timing of ACK/NACK for the data is specified by the narrowing signal arranged in the same slot as that of the data. For this reason, the terminal apparatus 200 can control the transmission timing of ACK/NACK on the basis of the downlink slot in which the data is arranged.

The narrowing signal may be transmitted as downlink control information (DCI) unique to each of the terminal apparatuses 200 or may be transmitted as DCI common to the group including the plurality of terminal apparatuses 200. This DCI may be different from a PDCCH used to transmit, for example, slot format information (SFI). The SFI transmitted by a group common PDCCH includes information on a format of the slot.

The transmission signal generated by mapping the data and the narrowing signal to the radio resources is subjected to the inverse fast Fourier transform by the IFFT unit 106 to be converted into the transmission signal in the time domain, and the CP is added to the transmission signal in the time domain by the CP adding unit 107. Then, the radio transmission processing is performed on the transmission signal by the radio transceiver 100c, and the transmission signal is transmitted to the terminal apparatus 200 through the antenna (Step S108).

As described above, the uplink transmission timing by the terminal apparatus 200 is set by the candidate notifying signal and the narrowing signal, such that the transmission timing of the terminal apparatus 200 can be flexibly controlled.

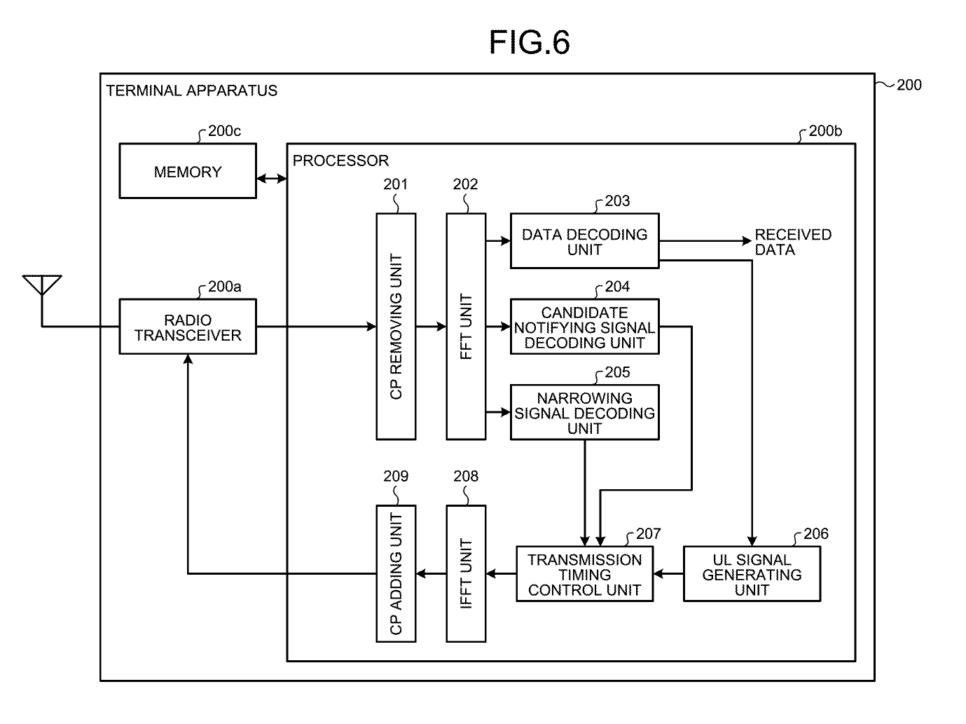

Next, a configuration and operations of the terminal apparatus 200 will be described. FIG. 6 is a block diagram illustrating a configuration of the terminal apparatus 200 according to the embodiment. The terminal apparatus 200 illustrated in FIG. 6 includes a radio transceiver 200a, a processor 200b, and a memory 200c.

In addition, the radio transceiver 200a receives a signal through an antenna, and performs radio reception processing such as down-conversion and A/D conversion on the received signal. The radio transceiver 200a outputs the received signal to the processor 200b. In addition, the radio transceiver 200a performs radio transmission processing such as D/A conversion and up-conversion on a transmission signal output from the processor 200b. The radio transceiver 200a transmits the transmission signal through the antenna.

The processor 200b includes, for example, a CPU, an FPGA, a DSP, or the like, and generally controls the entire terminal apparatus 200. Specifically, the processor 200b includes a CP removing unit 201, an FFT unit 202, a data decoding unit 203, a candidate notifying signal decoding unit 204, a narrowing signal decoding unit 205, an uplink signal generating unit (hereinafter referred to as an “UL signal generating unit”) 206, a transmission timing control unit 207, an IFFT unit 208, and a CP adding unit 209.

The CP removing unit 201 removes a CP added to the received signal. The CP removing unit 201 outputs the received signal after the removal of the CP to the FFT unit 202.

The FFT unit 202 performs fast Fourier transform on the received signal output from the CP removing unit 201 to convert the received signal into a received signal in a frequency domain. The received signal includes the candidate notifying signal or the data destined to the terminal apparatus 200 and the narrowing signal that are transmitted from the base station apparatus 100.

The data decoding unit 203 demodulates and decodes the received signal, and outputs received data. The data decoding unit 203 notifies whether or not the received data in which an error is not present has been acquired to the UL signal generating unit 206.

The candidate notifying signal decoding unit 204 demodulates and decodes the received signal to acquire the candidate notifying signal. That is, the candidate notifying signal decoding unit 204 decodes the candidate notifying signal transmitted at the time of starting communication with the base station apparatus 100 or at the time of changing the frame configuration to acquire the candidates for the uplink transmission timing for each subcarrier interval. The candidate notifying signal decoding unit 204 notifies the candidates for the transmission timing acquired from the candidate notifying signal to the transmission timing control unit 207.

The narrowing signal decoding unit 205 demodulates and decodes the received signal to acquire the narrowing signal. In this case, the narrowing signal decoding unit 205 acquires the narrowing signal from the control channel region for each slot of the received signal to acquire the uplink transmission timing based on the slot timing. The narrowing signal decoding unit 205 notifies the transmission timing acquired from the narrowing signal to the transmission timing control unit 207.

The UL signal generating unit 206 generates a signal transmitted in the uplink slot. Specifically, the UL signal generating unit 206 generates ACK/NACK depending on presence/absence of the error when it is notified whether or not the received data in which the error is not present has been acquired from the data decoding unit 203. That is, the UL signal generating unit 206 generates ACK when the error is not present in the received data, and generates NACK when the error is present in the received data. In addition, the UL signal generating unit 206 generates a desired uplink signal, for example, when the received data is a data indicating that the uplink transmission by the terminal apparatus 200 is permitted.

The transmission timing control unit 207 controls the transmission timing of the uplink signal generated by the UL signal generating unit 206. Specifically, the transmission timing control unit 207 performs a control to transmit the uplink signal at the transmission timing specified by the narrowing signal among the plurality of candidates for the transmission timing notified by the candidate notifying signal. Therefore, the transmission timing control unit 207 performs a control to transmit the signal using the uplink slot after the number of slots notified by the narrowing signal on the basis of the downlink slot in which the received signal is received. Since the candidate notifying signal indicates the candidates for the transmission timing for each subcarrier interval, the transmission timing control unit 207 controls the transmission timing of the uplink signal for each subcarrier interval.

The IFFT unit 208 performs inverse fast Fourier transform on the uplink signal of which transmission timing is controlled by the transmission timing control unit 207 to generate transmission signal in a time domain. The IFFT unit 208 outputs the transmission signal to the CP adding unit 209.

The CP adding unit 209 adds a CP to the transmission signal output from the IFFT unit 208. The CP adding unit 209 outputs the transmission signal to which the CP is added to the radio transceiver 200a.

The memory 200c includes, for example, a RAM, a ROM, or the like, and stores various pieces of information when processing is executed by the processor 200b.

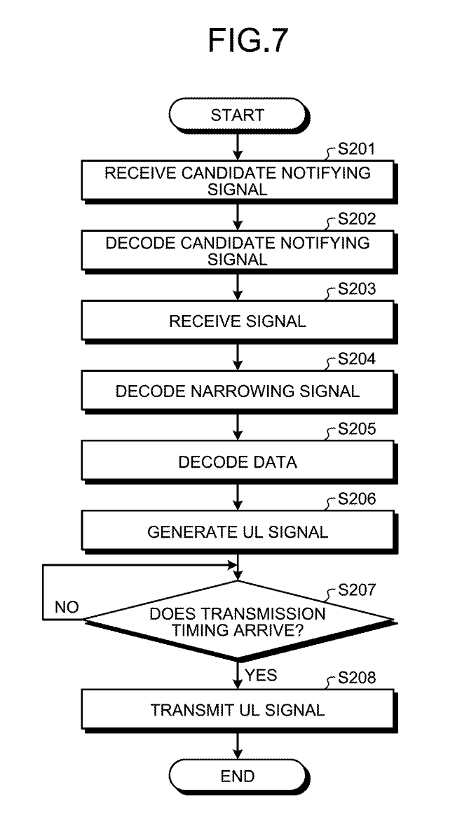

Next, operations of the terminal apparatus 200 configured as described above will be described with reference to a flowchart illustrated in FIG. 7.

At the time of starting the communication with the base station apparatus 100 or at the time of changing the frame configuration, the candidate notifying signal transmitted from the base station apparatus 100 is received by the radio transceiver 200a (Step S201). The candidate notifying signal passes through the CP removing unit 201 and the FFT unit 202, and is then decoded by the candidate notifying signal decoding unit 204 (Step S202). Since the candidate notifying signal indicates the candidates for the transmission timing for each subcarrier interval on the basis of the downlink slot, the candidates for the transmission timing of each subcarrier interval are notified to the transmission timing control unit 207.

Then, when radio communication between the base station apparatus 100 and the terminal apparatus 200 is started, a signal transmitted from the base station apparatus 100 in the downlink slot is received by the radio transceiver 200a (Step S203). The received signal is decoded by the data decoding unit 203 and the narrowing signal decoding unit 205. That is, the narrowing signal arranged in a control channel region of the received signal is decoded by the narrowing signal decoding unit 205 (Step S204), and the uplink transmission timing is acquired. Since the acquired transmission timing indicates the number of slots from a slot in which the data is received to the uplink slot, information on the transmission timing is notified to the transmission timing control unit 207.

In addition, data arranged in a data channel region of the received signal is decoded by the data decoding unit 203 (Step S205), and the received data is acquired. In this case, it is notified to the UL signal generating unit 206 whether or not the received data in which the error is not present has been acquired. When it is notified whether or not the error is present in the received data, an uplink signal for feeding back presence/absence of the error to the base station apparatus 100 is generated by the UL signal generating unit 206 (Step S206). Specifically, when the error is not present in the received data, the data is not to be retransmitted and ACK is thus generated, and when the error is present in the received data, the data is to be retransmitted and NACK is thus generated.

The uplink signal generated by the UL signal generating unit 206 is output to the transmission timing control unit 207, such that the transmission timing is controlled for each subcarrier interval. That is, after the data is received in the downlink slot, it is determined whether or not the timing of the uplink slot after the number of slots specified by the narrowing signal arrives (Step S207). At each subcarrier interval, while the timing of the uplink slot does not arrive (Step S207: No), transmission of the uplink signal is waited. When the timing of the uplink slot arrives (Step S207: Yes), the uplink signal passes through the IFFT unit 208 and the CP adding unit 209 and is then transmitted from the radio transceiver 200a to the base station apparatus 100 (Step S208).

As described above, according to the present embodiment, when the base station apparatus determines the frame configuration, the base station apparatus transmits the candidate notifying signal indicating the candidates for the unlink transmission timing for each subcarrier interval, and transmits the narrowing signal that narrows the actual transmission timing in each slot in the frame. The terminal apparatus transmits the uplink signal at the transmission timing specified by the narrowing signal among the candidates for the transmission timing notified by the candidate notifying signal. For this reason, the transmission timings of the respective terminal apparatuses can be individually set, such that the transmission timing can be flexibly set depending on the processing capability of the terminal apparatus.

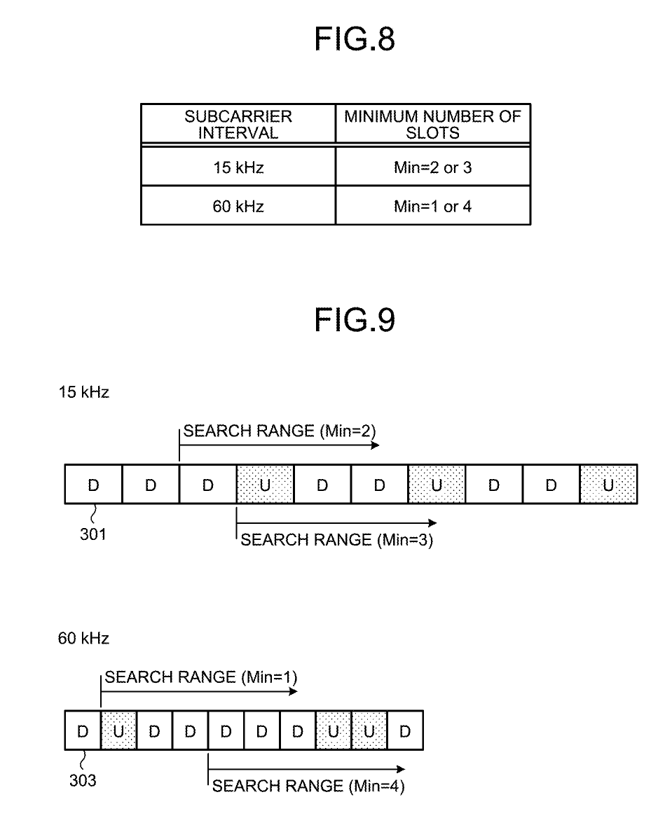

A case in which the candidate notifying signal indicates the numbers of slots from the downlink slot to the slots that can become the uplink slots for each subcarrier interval has been described in the abovementioned embodiment, but the candidates for the transmission timing may be indicated by other methods. For example, as illustrated in FIG. 8, the candidate notifying signal may indicate the minimum number of slots from the downlink slot to the uplink transmission timing for each subcarrier interval. In an example illustrated in FIG. 8, the candidate notifying signal indicates that uplink slots after two or three slots from the downlink slot are set to be candidates for the transmission timing in the subband with the subcarrier interval of 15 kHz. Likewise, the candidate notifying signal indicates that uplink slots after one slot or four slots from the downlink slot are set to candidates for the transmission timing in the subband with the subcarrier interval of 60 kHz.

In this case, the narrowing signal specifies which of the minimum numbers of slots is adopted at each subcarrier interval, and the terminal apparatus 200 searches for uplink slots from a slot after the specified minimum number of slots and sets the searched uplink slots to the transmission timing. Specifically, as illustrated in FIG. 9, a narrowing signal of a slot 301 of the subband with the subcarrier interval of 15 kHz specifies whether the minimum number of slots is two slots or three slots. The terminal apparatus 200 searches for uplink slots using slots after the two slots from the slot 301 as a search range when the minimum number of slots is the two slots, and searches for uplink slots using slots after the three slots from the slot 301 as a search range when the minimum number of slots is the three slots. The terminal apparatus 200 transmits the uplink signal using a subcarrier with the subcarrier interval of 15 kHz in the uplink slots detected from the search range.

Likewise, a narrowing signal of a slot 303 of the subband with the subcarrier interval of 60 kHz specifies whether the minimum number of slots is one slot or four slots. The terminal apparatus 200 searches for uplink slots using slots after the one slot from the slot 303 as a search range when the minimum number of slots is the one slot, and searches for uplink slots using slots after the four slots from the slot 303 as a search range when the minimum number of slots is the four slots. The terminal apparatus 200 transmits the uplink signal using a subcarrier with the subcarrier interval of 60 kHz in the uplink slots detected from the search range.

In this way, it is possible to increase the number of candidates for the transmission timing at each subcarrier interval, and since it is sufficient for the narrowing signal to designate one of the two minimum numbers of slots, the narrowing signal uses only one bit. That is, an increase in control information can be suppressed.

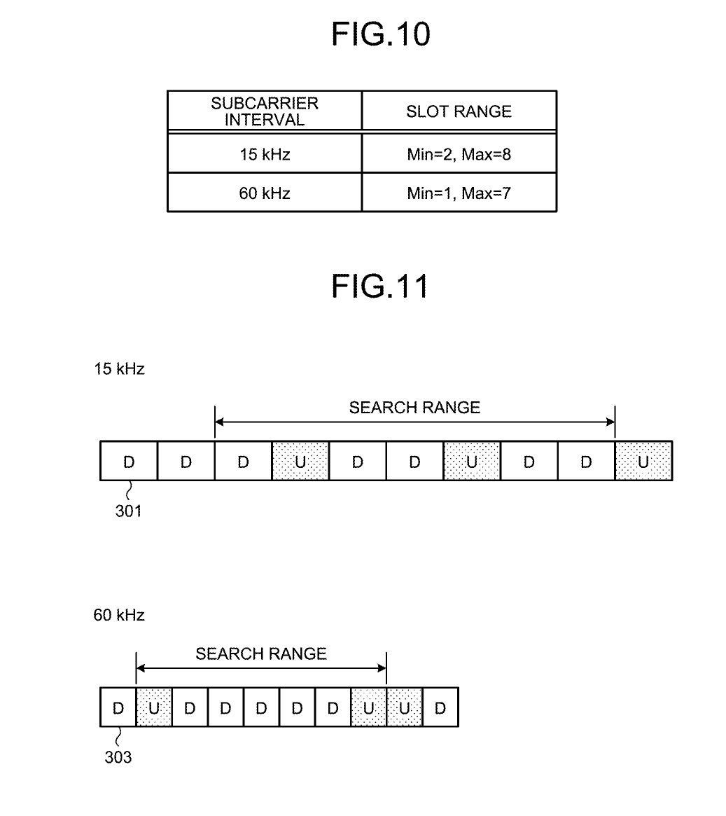

In addition, for example, as illustrated in FIG. 10, the candidate notifying signal may indicate a range of the number of slots from the downlink slot to the uplink transmission timing for each subcarrier interval. In an example illustrated in FIG. 10, the candidate notifying signal indicates that uplink slots in a range from a slot after two slots from the downlink slot to a slot after eight slots from the downlink slot are set to be candidates for the transmission timing in the subband with the subcarrier interval of 15 kHz. Likewise, the candidate notifying signal indicates that uplink slots in a range from a slot after one slot from the downlink slot to a slot after seven slots from the downlink slot are set to candidates for the transmission timing in the subband with the subcarrier interval of 60 kHz.

In this case, the narrowing signal specifies which of slots included in the range indicated by the candidate notifying signal is set to the transmission timing at each subcarrier interval. The candidate notifying signal designates the range of the candidates for the transmission timing, such that it is possible to reduce a size of the candidate notifying signal as compared with the case of designating individual candidates for the transmission timing.

In addition, a case in which the base station apparatus 100 transmits the narrowing signal in the control channel region of each downlink slot has been described in the abovementioned embodiment, but there may be a downlink slot in which the narrowing signal is not transmitted. That is, for example, in one downlink slot, a narrowing signal related to a plurality of downlink slots continuous from the corresponding downlink slot may be transmitted. In other words, uplink transmission timings corresponding to the plurality of downlink slots may be collectively specified by the narrowing signal of one downlink slot. Therefore, it is possible to reduce overhead of control information.

Further, in the abovementioned embodiment, the base station apparatus 100 can omit the transmission of the narrowing signal after transmitting the candidate notifying signal. That is, the terminal apparatus 200 may search for the uplink slots using the candidates for the transmission timing notified by the candidate notifying signal as the search range, and when detecting the uplink slot, set the detected uplink slot to the transmission timing.

For example, as illustrated in FIG. 10, when the range of the candidates for the transmission timing is designated, the terminal apparatus 200 searches for the uplink slots using the designated range as the search range as illustrated in FIG. 11. That is, when the terminal apparatus 200 transmits an uplink signal corresponding to a slot 301 of the subband with the subcarrier interval of 15 kHz, the terminal apparatus 200 searches for the uplink slots using a range from a slot after two slots from the slot 301 to a slot after eight slots from the slot 301 as the search range. The terminal apparatus 200 transmits the uplink signal in the uplink slots detected from the search range. In addition, when the terminal apparatus 200 transmits an uplink signal corresponding to a slot 303 of the subband with the subcarrier interval of 60 kHz, the terminal apparatus 200 searches for the uplink slots using a range from a slot after one slot from the slot 303 to a slot after seven slots from the slot 303 as the search range. The terminal apparatus 200 transmits the uplink signal in the uplink slots detected from the search range.

In addition, a case in which the candidate notifying signal and the narrowing signal specify the uplink transmission timing in units of slots has been described in the abovementioned embodiment, but the transmission timing may be specified in units of time different from the slots. Specifically, for example, the transmission timing may be designated in units of time such as symbols or minislots included in the slot.

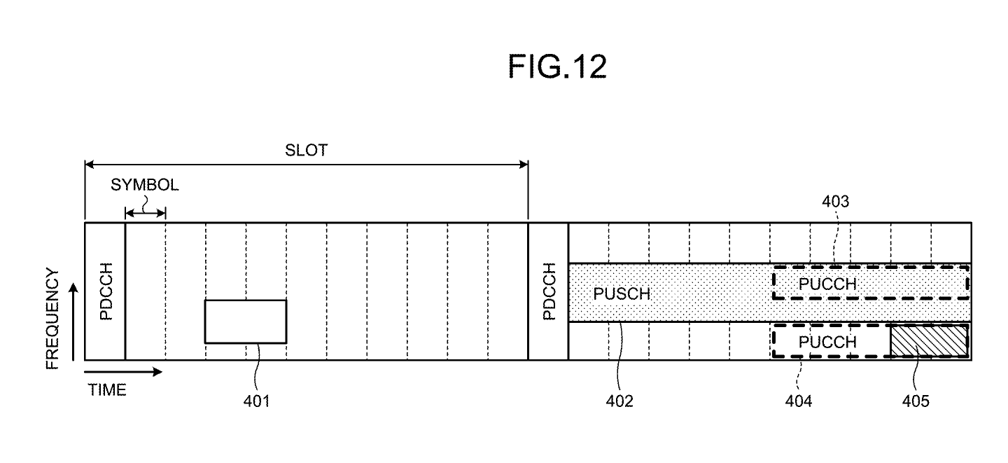

FIG. 12 is a view illustrating a specific example of a slot configuration when a signal is transmitted in units of minislots. In FIG. 12, two slots each including a plurality of symbols are illustrated. In any of the slots, a region including a head symbol is allocated to a physical downlink control channel (PDCCH). A region after the PDCCH is divided into minislots each including a plurality of symbols, and downlink or uplink signals are transmitted in each minislot.

In such a case, the base station apparatus 100 transmits a candidate notifying signal that specifies a slot including an uplink control channel as a candidate for a transmission timing. That is, in FIG. 12, a candidate notifying signal that identifies a second slot in which physical uplink control channels (PUCCHs) are likely to be disposed is transmitted. Slots in which the PUCCHs can be disposed may be different from each other for each subcarrier interval. Therefore, the candidate notifying signal specifies candidates for the transmission timing for each subcarrier interval. In a subband illustrated in FIG. 12, it is likely that the PUCCHs will be disposed in regions 403 and 404 of the second slot, and the candidate notifying signal thus indicates the second slot as the candidate for the transmission timing in relation to this subband. The candidate notifying signal is transmitted as a higher layer signal such as RRC signaling.

The base station apparatus 100 transmits a downlink signal using a minislot 401 including a plurality of symbols in a first slot. The base station apparatus 100 transmits a narrowing signal that narrows an uplink transmission timing corresponding to the downlink signal, in the second slot that becomes a candidate for the uplink transmission timing. That is, the base station apparatus 100 transmits a narrowing signal by the PDCCHs of the second slot, the narrowing signal specifying a minislot 405 among the regions 403 and 404 in which the PUCCHs can be disposed, as the uplink transmission timing. Therefore, after the terminal apparatus 200 receives the signal of the minislot 401, the terminal apparatus 200 receives the PDCCH of the second slot which becomes the candidate for the transmission timing, and detects that the minislot 405 is the uplink transmission timing. The terminal apparatus 200 transmits, for example, ACK/NACK for the signal of the minislot 401 in the minislot 405.

As illustrated in FIG. 12, the regions 403 and 404 that become candidates for the transmission timing may have the same time or frequency as that of a physical uplink shared channel (PUSCH) 402 on which uplink data are transmitted. That is, the PUSCH 402 and the PUCCH may be transmitted in the same slot or may be transmitted in different slots. When the PUSCH 402 and the PUCCH are transmitted in the same slot, the PUSCH 402 and the PUCCH may be multiplexed and transmitted at the same time.

According to one aspect of the base station apparatus, the terminal apparatus, the radio communication system, and the transmission timing setting method disclosed herein, an effect in which the transmission timing can be flexibly set is achieved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station apparatus comprising:
first processor circuitry that generates a first signal indicating first candidates for a transmission timing, wherein the first candidates are selected from a second candidates;
second processor circuitry that generates a second signal specifying one transmission timing from the first candidates for the transmission timing indicated by the first signal; and
a transmitter that transmits the first signal and the second signal.

2. The base station apparatus of claim 1, wherein the number of the second candidates are larger than that of the first candidates.

3. The base station apparatus of claim 1, wherein
the first processor circuitry generates the first signal indicating the candidates for the transmission timing by a length of a time from after a signal is received.

4. The base station apparatus of claim 3, wherein
the first processor circuitry generates the first signal indicating candidates for a number of slots from a slot in which the signal is received.

5. The base station apparatus of claim 3, wherein
the first processor circuitry generates the first signal indicating candidates for a number of slots corresponding to a shortest time from a slot in which the signal is received to a slot.

6. The base station apparatus of claim 3, wherein
the first processor circuitry generates the first signal specifying a range of a number of slots from a slot in which the signal is received to a slot.

7. A terminal apparatus comprising:
a receiver that receives a first signal indicating first candidates for a transmission timing for the terminal apparatus and a second signal specifying one transmission timing from the candidates for the transmission timing indicated by the first signal; and
a controller that controls a transmission timing of a signal based on the first signal and the second signal.

8. The terminal apparatus of claim 7, wherein the number of the second candidates are larger than the number of the first candidates, and the first candidates is selected from the second candidates.

9. The terminal apparatus of claim 7, wherein the receiver receives data to be configured for the terminal apparatus; further comprising
processor circuitry that generates a feedback signal indicating whether or not an error is present in the received data, wherein the controller controls a transmission timing of the feedback signal.

10. The base station apparatus of claim 1, wherein the candidates are continuous.

11. The base station apparatus of claim 1, wherein the candidates are non-continuous.

12. A transmission timing setting method comprising:
generating a first signal indicating a first candidates for a transmission timing, wherein the first candidates are selected from a second candidates;
generating a second signal specifying one transmission timing from the candidates for the transmission timing indicated by the first signal; and
transmitting the first signal and the second signal.

13. A transmission timing setting method comprising:
receiving a first signal indicating candidates for a transmission timing and a second signal specifying one transmission timing from the candidates for the transmission timing indicated by the first signal; and
controlling a transmission timing of a signal based on the first signal and the second signal.
